(19) United States
(12) Patent Application Publication
(10) Pub. No.: US 2021/0215850 A1
(43) Pub. Date: Jul. 15, 2021

(54) HEAD MOUNT DISPLAY

(71) Applicants: STARVR CORPORATION, New Taipei City (TW); Acer Incorporated, New Taipei City (TW)

(72) Inventors: Yi-Jung Chiu, New Taipei City (TW); Wei-Kuo Shih, New Taipei City (TW); Shih-Ting Huang, New Taipei City (TW); Yen-Hsien Li, New Taipei City (TW)

(73) Assignees: STARVR CORPORATION, New Taipei City (TW); Acer Incorporated, New Taipei City (TW)

(21) Appl. No.: 17/144,140

(22) Filed: Jan. 8, 2021

(30) Foreign Application Priority Data
Jan. 10, 2020 (TW) 109100846

(51) Int. Cl. G02B 1/118; G02B 3/08; G02B 5/00

(52) U.S. Cl. CPC G02B 1/118; G02B 5/003; G02B 3/08

(57) ABSTRACT

A head mount display including two display units respectively disposed in front of eyes of a user is provided. Each of the display units includes a display device, a Fresnel lens, and a plurality of moth eye structures. The Fresnel lens is disposed between the display device and one of the eyes of the user. The plurality of moth eye structures are located on at least one surface between the display device and the one of the eyes of the user.

### CROSS-REFERENCE TO RELATED APPLICATION

This application claims the priority benefit of Taiwan application serial no. 109100846, filed on Jan. 10, 2020. The entirety of the above-mentioned patent application is hereby incorporated by reference herein and made a part of this specification.

### BACKGROUND

### Field of the Disclosure

The disclosure relates to a display, and in particular to a head mount display.

### Description of Related Art

The head mount display is typically designed in the form of an eye mask or a helmet to set the display device in front of the user's eyes, and a lens element is adopted to project the image light output by the display device into the user's eyes. In order to reduce the size and weight of the head mount display, conventional head mount display adopts a Fresnel lens as a light guide element, but which has caused serious stray light problems.

FIG. 1 is a partial schematic diagram of a conventional head mount display 1. Please refer to FIG. 1. During the transmission of the image light B output by the display device 10 toward the user's eyes E, interface reflection R is likely to occur on the surface S11B of the Fresnel lens 11 to form stray light S. In addition, the display device 10 may reflect the stray light S to make the stray light problem more complicated/serious. In addition, when the image light B output by the display device 10 is incident on the mold release surface S110B of the Fresnel lens structure 110, it deviates from the designed light path and forms the stray light S. All of the above cause the image quality of the head mount display 1 to deteriorate. Therefore, how to reduce the size and weight of the head mount display while solving the problem of stray light has become one of the issues that require urgent solution from practitioners.

### SUMMARY OF THE DISCLOSURE

The present disclosure provides a head mount display, which has good display quality.

A head mount display of the present disclosure includes two display units respectively disposed in front of a user's eyes. Each display unit includes a display device, a Fresnel lens and multiple moth-eye structures. The Fresnel lens is placed between the display device and one of the user's eyes. The multiple moth-eye structures are disposed on at least one surface between the display device and one of the user's eyes.

In an embodiment of the present disclosure, the Fresnel lens structure of the Fresnel lens and the plurality of moth-eye structures are respectively located on two opposite surfaces of the Fresnel lens.

In an embodiment of the present disclosure, the plurality of moth-eye structures are located on the Fresnel lens structure of the Fresnel lens.

In an embodiment of the present disclosure, the aspect ratio of each of the plurality of moth-eye structures is greater than 1.

In an embodiment of the present disclosure, the pitch of the plurality of moth-eye structures is less than or equal to 750 nm.

In an embodiment of the present disclosure, the plurality of moth-eye structures are located on the display device and the Fresnel lens.

In an embodiment of the present disclosure, the Fresnel lens structure of the Fresnel lens includes a plurality of light guide surfaces and a plurality of mold release surfaces respectively connecting two adjacent light guide surfaces, and the plurality of mold release surfaces are anti-reflection surfaces.

In an embodiment of the present disclosure, each of the plurality of mold release surfaces is an atomized surface, or each of the plurality of mold release surfaces has at least one roughened structure, and the height difference of the at least one roughened structure is greater than 0.1 micron.

In an embodiment of the present disclosure, each of the two display units further includes a light absorbing layer disposed on each of the plurality of mold release surfaces.

In an embodiment of the present disclosure, each of the two display units includes a plurality of Fresnel lenses, and the plurality of Fresnel lenses are sequentially disposed between the display device and one of the user's eyes.

Based on the above, since the gradual equivalent refractive index provided by the moth-eye structure helps to reduce the reflectivity, by providing the multiple moth-eye structures on the at least one surface between the display device and one of the user's eyes, it helps to reduce the interface reflection in the head mount display to effectively avoid the stray light problem. Therefore, the head mount display of the embodiment of the present disclosure can have good display quality.

In order to make the above features and advantages of the present disclosure more comprehensible, embodiments are described below in detail with the accompanying drawings as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the disclosure.

FIG. 1 is a partial schematic diagram of a conventional head mount display.

FIG. 2 is a schematic diagram of a head mount display according to a first embodiment of the present disclosure.

FIG. 3 is a partial schematic diagram of multiple moth-eye structures in FIG. 2.

FIG. 4A to FIG. 4H are partial schematic diagrams of other implementations of the Fresnel lens in FIG. 2.

FIG. 5 to FIG. 8 are schematic diagrams of head mount displays according to the second to fifth embodiments of the present disclosure, respectively.

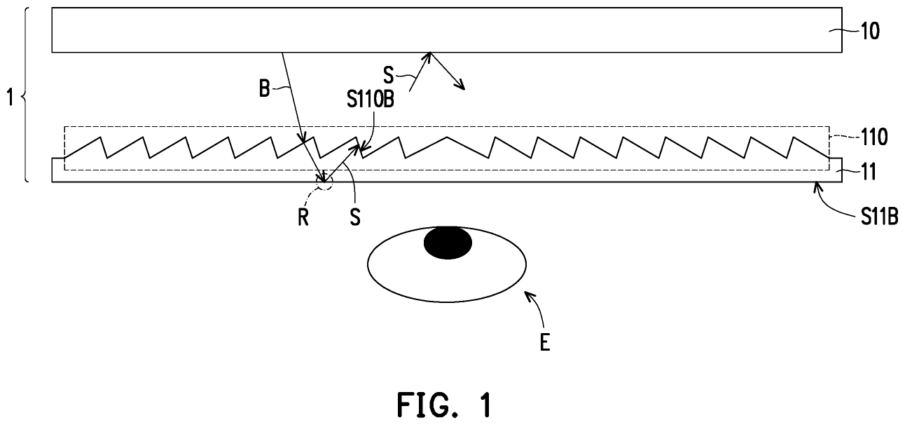

### DESCRIPTION OF EMBODIMENTS

The directional terminologies mentioned in the detailed description, such as “top”, “bottom”, “front”, “back”, “left”, or “right”, etc., are used with reference to the orientation of the FIG(s) being described. Accordingly, the drawings and descriptions will be regarded as illustrative in nature and not as restrictive. In the drawings, the figures show typical features of the methods, structures, and/or materials used in the particular exemplary embodiments. However, the drawings are not to be interpreted as limiting or limiting the scope or nature of the exemplary embodiments disclosed. For example, for clarity, the relative size, thickness and location of the various layers, regions and/or structures may be reduced or magnified.

In the exemplary embodiments, the same or similar elements will be given the same or similar reference numerals and their description will be omitted. In addition, the features in the different exemplary embodiments can be combined with each other as long as there is no conflict, and equivalent changes and modifications made in the specification or claims are still within the scope of this disclosure. Moreover, “first”, “second”, etc. mentioned in the specification and the claims are merely used to name the discrete elements or to differentiate different ranges or embodiments and therefore should not be regarded as limiting the upper or lower bound of the number of the components/devices and should not be used to limit the manufacturing sequence of components.

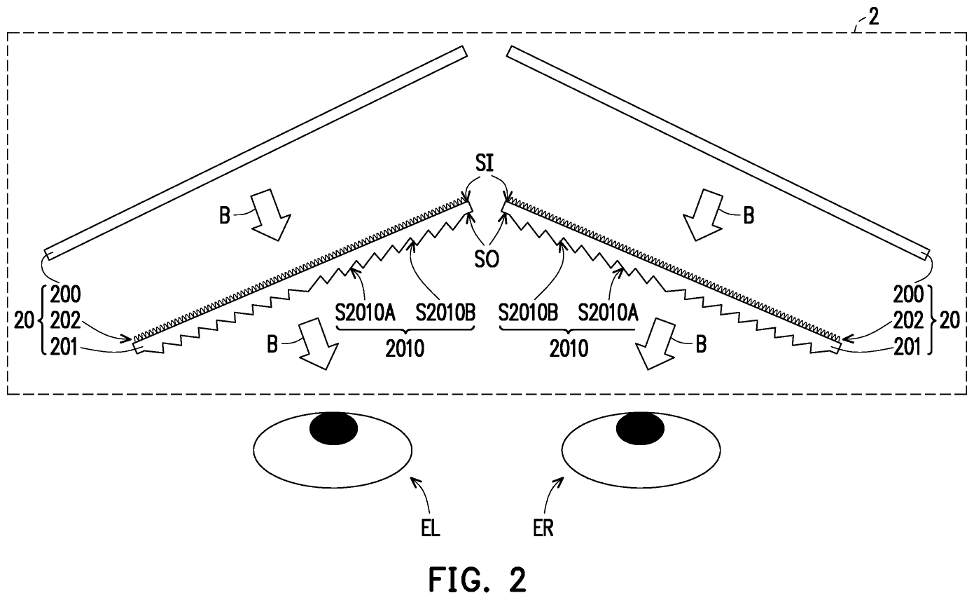

FIG. 2 is a schematic diagram of a head mount display according to a first embodiment of the present disclosure. Please refer to FIG. 2, the head mount display 2 includes two display units 20 respectively disposed in front of the user's eyes (left eye EL and right eye ER). Each of the display units 20 includes a display device 200, a Fresnel lens 201, and a plurality of moth-eye structures 202.

The display device 200 is adapted to provide image light B with image information (such as grayscale, color, etc.). For example, the display device 200 may be a liquid crystal display, but is not limited thereto.

The Fresnel lens 201 is disposed between the display device 200 and the user's left eye EL (or right eye ER), and the Fresnel lens 201 is adapted to guide the image light B output by the display device 200 to the user's left eye EL (or right eye ER). The Fresnel lens 201 has a Fresnel lens structure 2010, and the Fresnel lens structure 2010 includes a plurality of light guide surfaces S2010A and a plurality of mold release surfaces S2010B respectively connecting two adjacent light guide surfaces S2010A. When the Fresnel lens structure 2010 is a convex lens, the mold release surface S2010B is closer to the center of the Fresnel lens structure 2010 than the corresponding light guide surface S2010A. On the contrary, when the Fresnel lens structure 2010 is a concave lens, the mold release surface S2010B is farther from the center of the Fresnel lens structure 2010 than the corresponding light guide surface S2010A. FIG. 2 schematically illustrates the architecture of a Fresnel lens structure 2010 as a convex lens.

The plurality of moth-eye structures 202 are disposed on at least one surface between the display device 200 and one of the user's eyes. For example, the plurality of moth-eye structures 202 may be located on the inner surface SI (the surface facing the display device 200) or the outer surface SO (the surface facing the user) of the Fresnel lens 201. In addition, the configuration surface of the Fresnel lens structure 2010 of the Fresnel lens 201 may also be the inner surface SI or the outer surface SO of the Fresnel lens 201. FIG. 2 schematically illustrates that the Fresnel lens structure 2010 and the multiple moth-eye structures 202 are respectively located on two opposite surfaces of the Fresnel lens 201, wherein the Fresnel lens structure 2010 is located on the outer surface SO of the Fresnel lens 201, and the multiple moth-eye structures 202 are located on the inner surface SI of the Fresnel lens 201. By arranging the multiple moth-eye structures 202 on the inner surface SI of the Fresnel lens 201, it is possible to avoid damage (such as scratches) and contamination (such as dust or fingerprints) caused to the multiple moth-eye structures 202 due to human or environmental factors while helping to extend the service life of the head mount display 2. However, the configuration surfaces of the multiple moth-eye structures 202 and the relative arrangement relationship between the multiple moth-eye structures 202 and the Fresnel lens structure 2010 are not limited to those shown in FIG. 2. For example, the Fresnel lens structure 2010 may be located on the inner surface SI of the Fresnel lens 201, and the plurality of moth-eye structures 202 may be located on the outer surface SO of the Fresnel lens 201. Alternatively, the plurality of moth-eye structures 202 may also be located on at least one of the other surfaces between the display device 200 and one of the user's eyes.

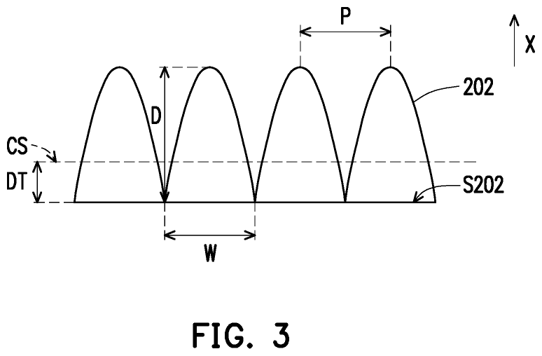

FIG. 3 is a partial schematic diagram of multiple moth-eye structures in FIG. 2. Please refer to FIG. 3, the moth-eye structure 202 is a nano-scale columnar structure, and the width W (or diameter) of the moth-eye structure 202 is gradually decreased in a direction X away from the configuration surface 5202 of the multiple moth-eye structures 202. Here, the configuration surface 5202 of the multiple moth-eye structures 202 may be any surface between the display device 200 in FIG. 2 and one of the user's eyes.

Since the width W of the moth-eye structure 202 is gradually decreased toward the direction X, in the section CS parallel to the configuration surface 5202, the area occupied by air increases as the distance DT between the section CS and the configuration surface 5202 increases, and the area occupied by the multiple moth-eye structures 202 decreases as the distance DT increases. Since the refractive index of air is smaller than the refractive index of the moth-eye structure 202, the equivalent refractive index at the section CS decreases as the distance DT increases. That is, the equivalent refractive index decreases along the direction X.

According to the formula of reflectivity, when the refractive index difference between two media is larger, the reflectivity at the interface of the two media is higher. Therefore, by setting the moth-eye structure 202 providing a gradient equivalent refractive index at the interface between the two media with a large refractive index difference, it helps to reduce the reflectivity (interface reflection) at the interface. For example, the plurality of moth-eye structures 202 may be provided on at least one surface (any surface having an interface reflection problem) between the display device 200 and one of the user's eyes to reduce the interface reflection in the head mount display 2 to effectively solve the stray light problem.

In FIG. 2, the plurality of moth-eye structures 202 are located on the inner surface SI of the Fresnel lens 201, thereby helping to reduce the stray light formed by the interface reflection on the inner surface SI of the Fresnel lens 201. In addition, since the stray light (i.e., the light reflected by the inner surface of the Fresnel lens 201) formed at the inner surface SI of the Fresnel lens 201 is transmitted to the display device 200 and then reflected by the display device 200, which causes the stray light problem to be more complicated/serious (e.g., forming ghosting), reducing the stray light formed at the inner surface SI of the Fresnel lens 201 also helps to solve the ghosting problem. Therefore, the head mount display 2 can have good display quality.

The variation rate of the equivalent refractive index where the multiple moth-eye structures 202 are located can be designed based on the depth D and width W of each of the multiple moth-eye structures 202. When the aspect ratio (ratio of depth D to width W) of each of the plurality of moth-eye structures 202 is greater than 1, the variation of the equivalent refractive index will not be too drastic, and the effect of equivalent refractive index gradation can be achieved.

In addition, the pitch P of the plurality of moth-eye structures 202 can be designed according to the wavelength range used by the head mount display 2. When the wavelength range is limited to visible light, the pitch P of the plurality of moth-eye structures 202 is, for example, less than or equal to 750 nm.

The head mount display 2 may further include other elements or films depending on different needs. For example, the head mount display 2 may further include at least one anti-reflection layer (not shown) to further reduce the interface reflection in the head mount display 2. The at least one anti-reflection layer may be disposed on at least one surface between the display device 200 and one of the user's eyes, for example, disposed on a surface of the display device 200 facing the Fresnel lens 201 to decrease the interface reflection at the surface. However, the configuration surface of the at least one anti-reflection layer is not limited thereto. The following embodiments may further provide the at least one anti-reflection layer according to requirements, which will not be repeated below.

In addition, since the light incident into the mold release surface S2010B also forms stray light and affects the image quality (such as image smear), the multiple mold release surfaces S2010B of the Fresnel lens structure 2010 can be further designed as anti-reflection surfaces in order to reduce the directivity of stray light, so that the light intensity of stray light transmitted to the user's eyes is reduced, thereby effectively solving problems such as image smearing.

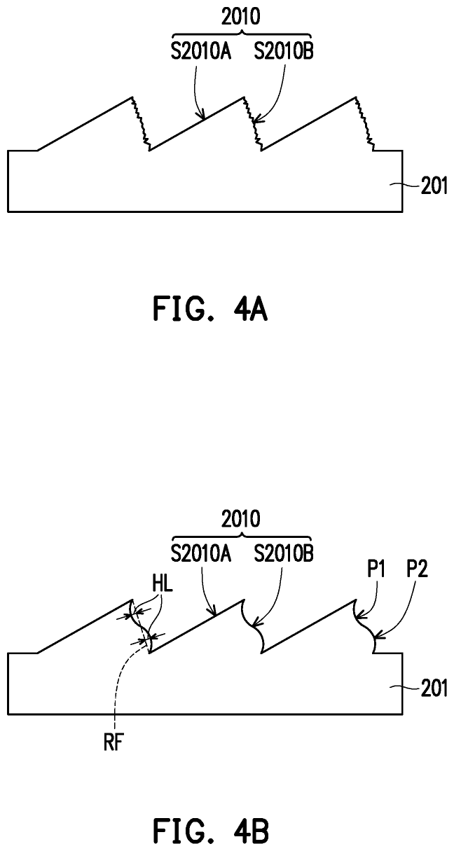

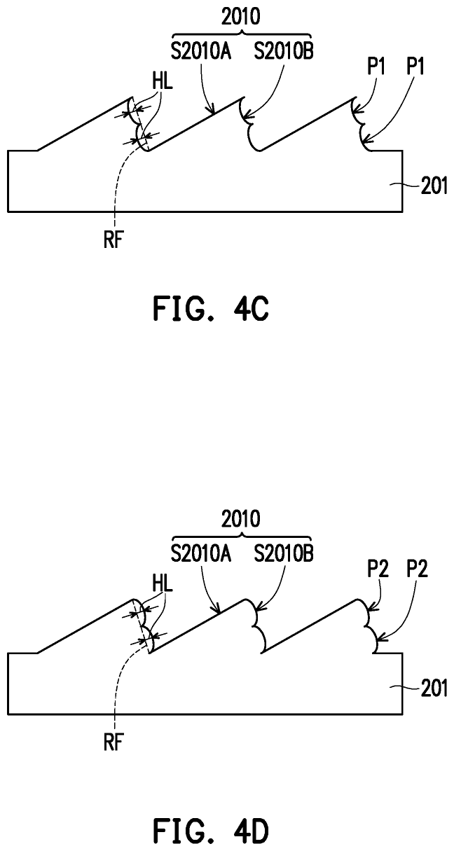

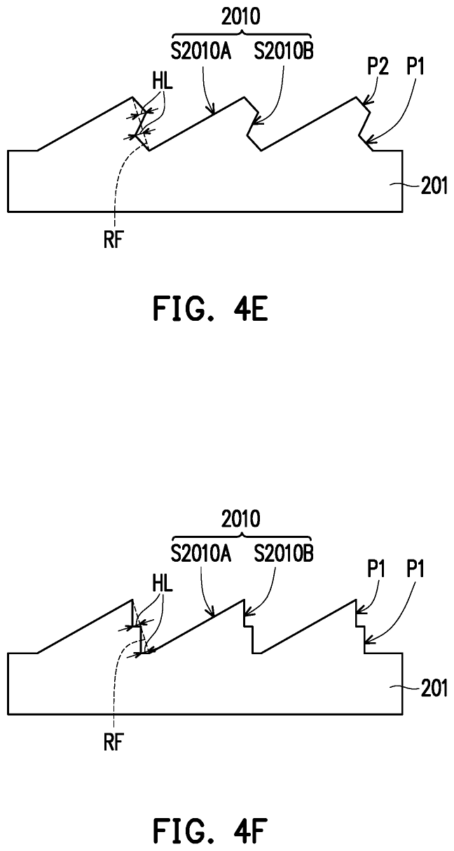

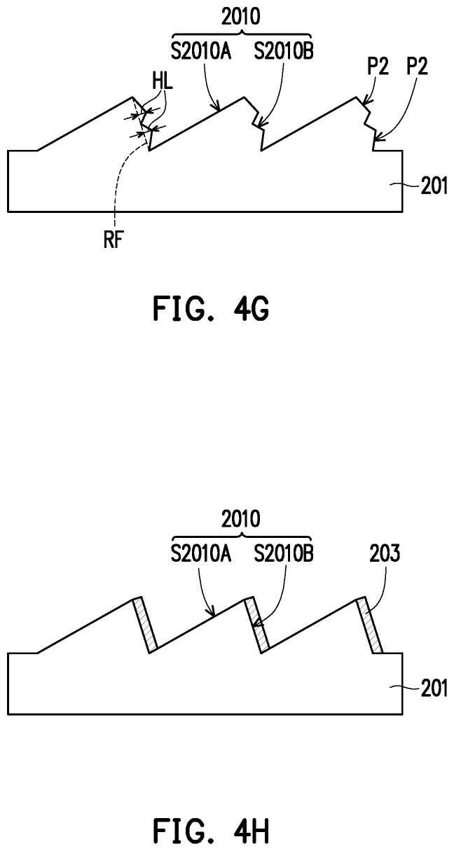

FIG. 4A to FIG. 4H are partial schematic diagrams of other implementations of the Fresnel lens 201 in FIG. 2. As shown in FIG. 4A to FIG. 4G, the topography of the mold release surface S2010B can be changed by changing the mold for making the Fresnel lens 201, for example, by changing the smooth mold release surface S2010B shown in FIG. 2 to the non-smooth (rugged) mold release surface S2010B shown in FIG. 4A to FIG. 4G so as to achieve the anti-reflection effect. Alternatively, as shown in FIG. 4H, each of the two display units 20 (refer to FIG. 2) may further include a light absorbing layer 203 provided on each of the plurality of mold release surfaces S2010B, and through the light absorbing layer 203 that absorbs the light transmitted to the mold release surface S2010B, the effect of anti-reflection can be achieved.

In FIG. 4A, each of the plurality of mold release surfaces S2010B of the Fresnel lens structure 2010 is an atomized surface (roughened surface). In FIG. 4B to FIG. 4G, each of the plurality of mold release surfaces S2010B of the Fresnel lens structure 2010 has at least one roughened structure. The roughened structure may be a concave portion P1 or a convex portion P2. The shape of the concave portion P1 (or the convex portion P2) may be a circular arc shape or a zigzag shape. In addition, the height difference HL of the roughened structure is greater than 0.1 micron to effectively diffuse the stray light to a large extent, thereby effectively reducing the light intensity of the stray light transmitted to the user's eyes. The height difference HL is defined as the distance between the most concave portion of the concave portion P1 (or the most convex portion of the convex portion P2) and the reference plane RF. The reference plane RF is a surface formed by a connection line from the highest to the lowest points of the mold release surface S2010B.

As shown in FIG. 4B and FIG. 4E, each of the plurality of mold release surfaces S2010B of the Fresnel lens structure 2010 may have two roughened structures, such as a concave portion P1 and a convex portion P2. In FIG. 4B, the concave portion P1 and the convex portion P2 are circular arc-shaped. In FIG. 4E, the concave portion P1 and the convex portion P2 both are formed in a zigzag shape.

As shown in FIG. 4C and FIG. 4F, each of the plurality of mold release surfaces S2010B of the Fresnel lens structure 2010 may have two roughened structures, such as two concave portions P1. In FIG. 4C, the two concave portions P1 are both circular arc-shaped. In FIG. 4F, the two concave portions P1 both are formed in a zigzag shape.

As shown in FIG. 4D and FIG. 4G, each of the plurality of mold release surfaces S2010B of the Fresnel lens structure 2010 may have two roughened structures, such as two convex portions P2. In FIG. 4D, the two convex portions P2 are circular arc-shaped. In FIG. 4G, the two convex portions P2 both are formed in a zigzag shape.

It should be noted that the number of roughened structures of each of the plurality of mold release surfaces S2010B of the Fresnel lens structure 2010 and the shape of the roughened structure may be changed as required, and are not limited as shown in FIG. 4B to FIG. 4G. In other embodiments, the number of roughened structures of the mold release surface S2010B may be one or greater than two. In addition, when the number of roughened structures of the release surface S2010B is greater than or equal to two, the roughened structure may be in a circular arc shape, a zigzag shape, or a combination of the above two shapes. It should also be noted that the mold release surface S2010B in the following embodiments can also be improved to an anti-reflection surface in the same way as described above, which will not be repeated hereafter.

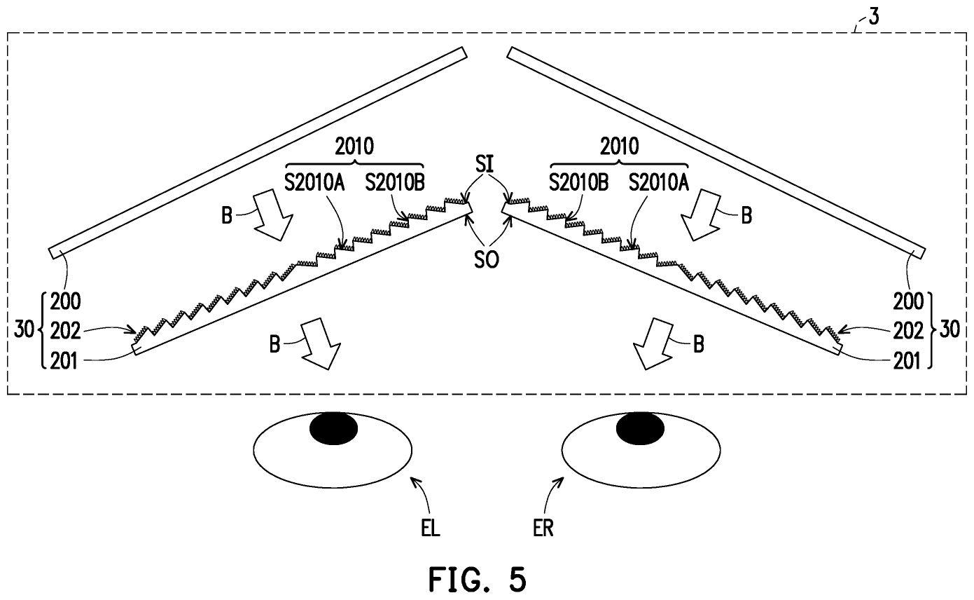

FIG. 5 to FIG. 8 are schematic diagrams of head mount displays 3, 4, 5 and 6 according to the second to fifth embodiments of the present disclosure, respectively. Please refer to FIG. 5. The main differences between the head mount display 3 and the head mount display 2 of FIG. 2 are as follows. In the display unit 30 of the head mount display 3, the configuration surface of the Fresnel lens structure 2010 is the inner surface SI of the Fresnel lens 201, and the plurality of moth-eye structures 202 are located on the Fresnel lens structure 2010 of the Fresnel lens 201, for example, located on multiple light guide surfaces 52010A of the Fresnel lens structure 2010, but is not limited thereto. For example, the multiple moth-eye structures 202 may also be located on the multiple light guide surfaces 52010A and the multiple mold release surfaces 52010B.

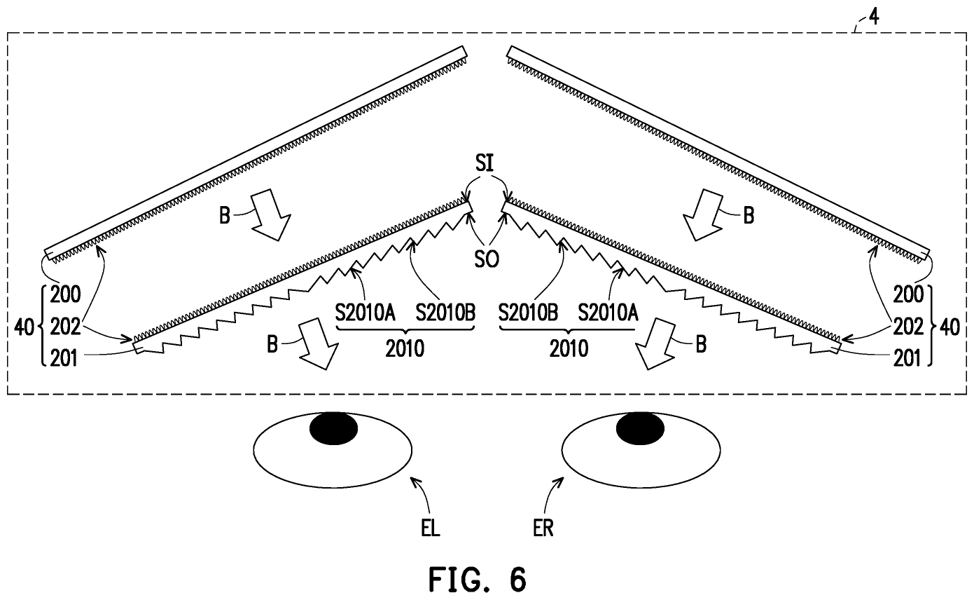

Please refer to FIG. 6. The main differences between the head mount display 4 and the head mount display 2 of FIG. 2 are as follows. In the display unit 40 of the head mount display 4, the plurality of moth-eye structures 202 are not only located on the Fresnel lens 201 but also located on the display device 200. In this manner, it is possible to further reduce the interface reflection occurring at the interface between the display device 200 and air. Any embodiment of the present disclosure can be improved in the same way, and no repetition is incorporated hereafter.

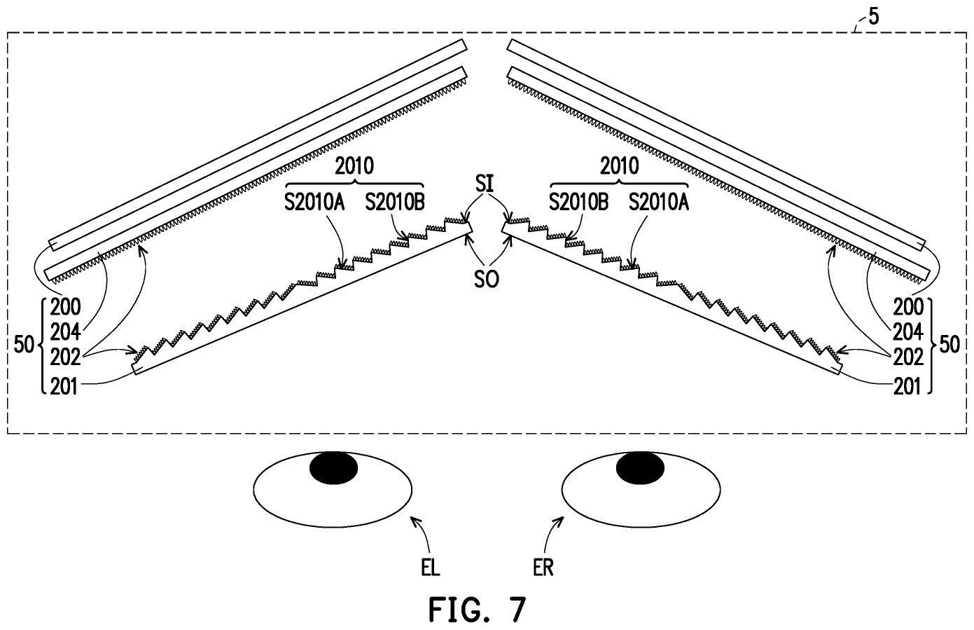

Please refer to FIG. 7. The main differences between the head mount display 5 and the head mount display 3 of FIG. 5 are as follows. The display unit 50 of the head mount display 5 further includes an optical film 204 located between the display device 200 and the Fresnel lens 201. In addition, the multiple moth-eye structures 202 are located on the optical film 204 in addition to the Fresnel lens 201. Specifically, the optical film 204 may be any optical element or optical layer provided between the display device 200 and the Fresnel lens 201 as required. By disposing the plurality of moth-eye structures 202 on the optical film 204, it is helpful to reduce the interface reflection occurring at the interface between the optical film 204 and air. FIG. 7 schematically illustrates that the plurality of moth-eye structures 202 are located on one surface of the optical film 204. However, in other embodiments, the multiple moth-eye structures 202 may be located on two opposite surfaces of the optical film 204. Any embodiment of the present disclosure can be improved in the same way, and no repetition is incorporated hereafter.

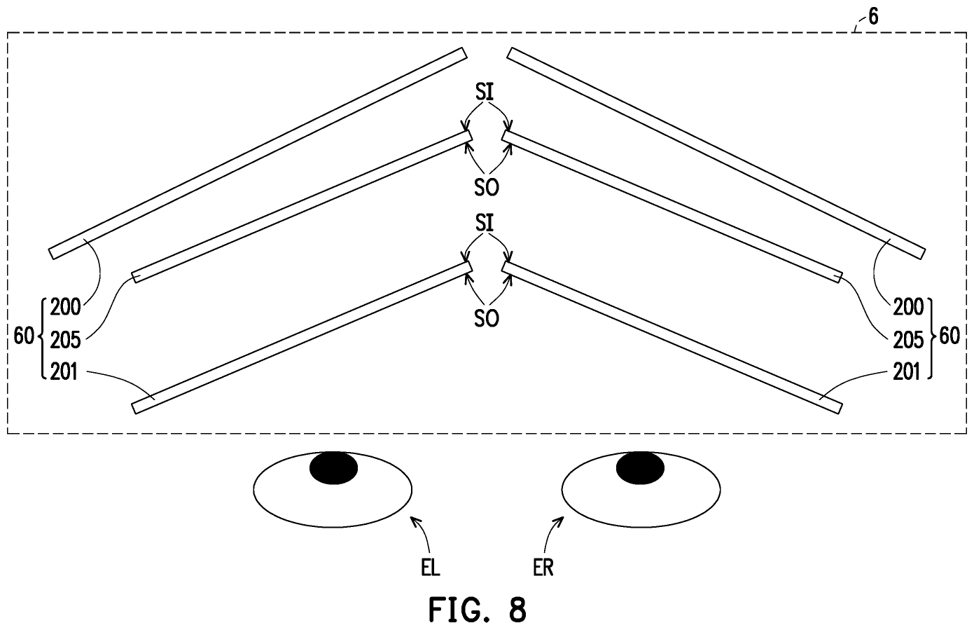

Please refer to FIG. 8. The main differences between the head mount display 6 and the head mount display 2 of FIG. 2 are as follows. The display unit 60 of the head mount display 6 includes a plurality of Fresnel lenses (such as Fresnel lens 205 and Fresnel lens 201), and the plurality of Fresnel lenses (such as Fresnel lens 205 and Fresnel lens 201) are sequentially disposed between the display device 200 and one of the user's eyes. FIG. 8 omits illustration of the multiple moth-eye structures and the Fresnel lens structure of each of the Fresnel lenses. However, the multiple moth-eye structures may be disposed on at least one of the multiple surfaces (e.g., the surface of the display device 200 facing the Fresnel lens 205, the inner surface SI of the Fresnel lens 205, the outer surface SO of the Fresnel lens 205, the inner surface SI of the Fresnel lens 201, the outer surface SO of the Fresnel lens 201, the inner surface or outer surface of the optical film (if any)) between the display device 200 and one of the user's eyes. In addition, the Fresnel lens structure of the Fresnel lens 205 (or Fresnel lens 201) may be located on the outer surface SO or the inner surface SI of the Fresnel lens 205 (or Fresnel lens 201).

In summary, since the gradient equivalent refractive index provided by the moth-eye structure helps reduce reflectivity, by providing the plurality of moth-eye structures on at least one surface between the display device and one of the user's eyes, it helps reduce interface reflection in head mount display to effectively solve stray light issues. Therefore, the head mount display of the embodiment of the present disclosure can have good display quality. In an embodiment, an anti-reflection layer may be provided on at least one surface between the display device and one of the user's eyes to further reduce the interface reflection. In another embodiment, the multiple mold release surfaces of the Fresnel lens structure may be designed as anti-reflection surfaces to reduce the directivity of stray light and reduce the light intensity of stray light transmitted to the user's eyes. In yet another embodiment, the multiple moth-eye structures may be provided on a display device or an optical film (if any). In still another embodiment, the display unit may include a plurality of Fresnel lenses, and the plurality of moth-eye structures may be disposed on at least one of the plurality of Fresnel lenses.

Although the present disclosure has been disclosed in the above embodiments, it is not intended to limit the present disclosure, and those skilled in the art can make some modifications and refinements without departing from the spirit and scope of the disclosure. Therefore, the scope of the present disclosure is subject to the definition of the scope of the appended claims.

What is claimed is:

1. A head mount display comprising:
two display units respectively disposed in front of a user's eyes, wherein each of the two display units comprises:
a display device;
a Fresnel lens disposed between the display device and one of the user's eyes; and
a plurality of moth-eye structures disposed on at least one surface between the display device and one of the user's eyes.

2. The head mount display of claim 1, wherein a Fresnel lens structure of the Fresnel lens and the plurality of moth-eye structures are respectively located on two opposite surfaces of the Fresnel lens.

3. The head mount display of claim 1, wherein the plurality of moth-eye structures are located on a Fresnel lens structure of the Fresnel lens.

4. The head mount display of claim 1, wherein an aspect ratio of each of the plurality of moth-eye structures is greater than 1.

5. The head mount display of claim 1, wherein a pitch of the plurality of moth-eye structures is less than or equal to 750 nm.

6. The head mount display of claim 1, wherein the plurality of moth-eye structures are located on the display device and the Fresnel lens.

7. The head mount display of claim 1, wherein a Fresnel lens structure of the Fresnel lens comprises a plurality of light guide surfaces and a plurality of mold release surfaces respectively connected to two of the adjacent light guide surfaces, and the plurality of mold release surfaces are anti-reflection surfaces.

8. The head mount display of claim 7, wherein each of the plurality of mold release surfaces is an atomized surface or each of the plurality of mold release surfaces has at least one roughened structure, a height difference of the at least one roughened structure is greater than 0.1 micron.

9. The head mount display of claim 7, wherein each of the two display units further comprises:
a light absorbing layer provided on each of the plurality of mold release surfaces.

10. The head mount display of claim 1, wherein each of the two display units comprises a plurality of Fresnel lenses, and the plurality of Fresnel lenses are sequentially disposed between the display device and the one of the user's eyes.
